(19) United States
(12) Patent Application Publication
(10) Pub. No.: US 2021/0277634 A1
(43) Pub. Date: Sep. 9, 2021

(54) METHOD AND APPARATUS FOR MANAGING DISTRIBUTION OF WATER

(71) Applicant: Fuente Technologies, LLC, Austin, TX (US)

(72) Inventors: Christopher D. Eckhoff, Austin, TX (US); Lynn Sherman, Austin, TX (US)

(73) Assignee: Fuente Technologies, LLC, Austin, TX (US)

(21) Appl. No.: 17/192,859

(22) Filed: Mar. 4, 2021

Related U.S. Application Data
(60) Provisional application No. 62/985,230, filed on Mar. 4, 2020.

(51) Int. Cl. E03B 7/07; E03B 7/02; G05B 19/042; A01G 25/16

(52) U.S. Cl. CPC E03B 7/075; E03B 7/02; G05B 2219/2625; A01G 25/16; G05B 19/042

(57) ABSTRACT

Methods and apparatus for managing demand for water based on the state of a water utility are described. One method of managing distribution of water from the water utility includes the steps of: i) collecting water utility state information, ii) analyzing the state information to determine whether to inhibit irrigation by customers receiving water from the water utility, and iii) inhibiting irrigation based at least in part on the state information. Another method of managing distribution of water from the water utility includes the steps of: i) collecting water utility state information, ii) analyzing the state information to determine whether to inhibit irrigation by customers receiving water from the water utility, and iii) transmitting a control signal to inhibit irrigation if step ii) determines irrigation should be inhibited.

### CROSS-REFERENCE TO RELATED APPLICATIONS

This non-provisional application claims the benefit of U.S. provisional patent application no. 62/985,230 filed Mar. 4, 2020 which is incorporated herein by reference.

### FIELD OF THE INVENTION

The present invention relates to method and apparatus for managing distribution of water from a water utility to consumers/customers.

### BACKGROUND

A utility maintains the infrastructure for delivering a good or service to customers. Utilities are often granted a limited geographic monopoly for providing the good or service. Utilities tend to be regulated under federal, state, and sometimes local law (e.g., municipality). Regulation may include economic regulation. Utilities may also be subject to regulation as to quality or availability of goods and services and safety. Obligations or constraints may be imposed on utilities with the objective of maintaining availability of the good or service for the utility's captive customers. Examples of goods or services the distribution of which is managed by utilities include water, electricity, natural gas, and propane.

Demand for the good or service can fluctuate based on a number of factors. For example, demand can vary based on the time of day, time of week, and time of year. Demand can vary on a seasonal basis or in response to factors such as temperature or weather. In order to meet peak demand, the utility may pursue managing the supply, the demand, or both. The difference between the supply capability and the demand is the capacity.

In order to meet increasing peak demand loads the utility may increase supplies or production capabilities. In response to increased demand for electricity for example, a utility might manage supply by increasing power plant production or bringing additional generating units online. The utility might purchase additional goods or services to meet demand but the acquisition of additional supply to handle short-term demand peaks can result in high marginal costs for providing the good or service. When the capacity is routinely reduced below a given threshold, the utility may be forced to develop new supplies or production capability to lessen reliance on short-term purchases. The development of new supplies or production capability and accompanying infrastructure and delivery systems for a longer-term solution can be extremely capital intensive.

A utility may attempt to manage demand in order to preserve capacity. In severe shortage situation, an electric utility can resort to rolling blackouts where customers are grouped and the utility deprives one or more groups of electricity while providing electrical service to the other groups on a rotating basis.

A rolling blackout equivalent for a water or gas utility is not feasible. Loss of pressure in a potable water distribution system can result in contaminating elements moving from outside distribution lines into the line via breaks, cracks, and joints or as a result of back siphonage. Once service is restored, customers are then required to boil water for a period of time before potable use until potential contamination issues have been resolved. Rotating blackouts would result in simply growing the extent of potential contamination of the water distribution system. Another concern is that cutting off all water to an area adversely impacts critical uses such as fire hydrants. Alternative approaches are needed for managing demand for resources including water, gas, and other resources.

### SUMMARY

One embodiment of a method of managing distribution of water from a water utility includes the steps of: i) collecting water utility state information, ii) analyzing the state information to determine whether to inhibit irrigation by customers receiving water from the water utility, and iii) inhibiting irrigation based at least in part on the state information.

Another embodiment of a method of managing distribution of water from a water utility includes the steps of: i) collecting water utility state information, ii) analyzing the state information to determine whether to inhibit irrigation by customers receiving water from the water utility, and iii) transmitting a control signal to inhibit irrigation if step ii) determines irrigation should be inhibited.

One embodiment of an apparatus for managing distribution of water from a water utility includes a receiver for receiving a control signal from the water utility. The control signal includes an indication of whether irrigation should be inhibited. The apparatus includes a processor coupled to receive the control signal from the receiver. The processor determines from the content of the control signal whether the control signal is applicable to the apparatus based on at least one of an id of the apparatus and a location of the apparatus, wherein if the control signal is applicable and indicates irrigation should be inhibited, the processor generates an inhibit signal to inhibit irrigation for provision to an irrigation controller.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings in which like references indicate similar elements and in which:

FIG. 1 illustrates elements of one embodiment of water utility infrastructure and a computing device to generate a control signal for managing water demand.

FIG. 2 illustrates one embodiment of a water distribution infrastructure before and after a customer meter including a residential irrigation system incorporating the invention.

FIG. 3 illustrates one embodiment of a method of generating the control signal by the computing device.

FIG. 4 illustrates one embodiment of a method for a decision device to determine whether to select or de-select an irrigation inhibit mode based on the control signal.

FIG. 5 illustrates one embodiment of a decision device.

FIG. 6 illustrates one embodiment of a decision device coupled to an irrigation controller.

FIG. 7 illustrates one embodiment of a method of inhibiting irrigation based at least in part on water utility state information.

For simplicity and clarity of illustration, elements illustrated in the drawings have not necessarily been drawn to scale. For example, the dimensions of some of the elements are exaggerated relative to other elements for clarity. Further, where considered appropriate, reference numerals have been repeated among the drawings to indicate corresponding or analogous elements or multiple instances of the same element.

### DETAILED DESCRIPTION

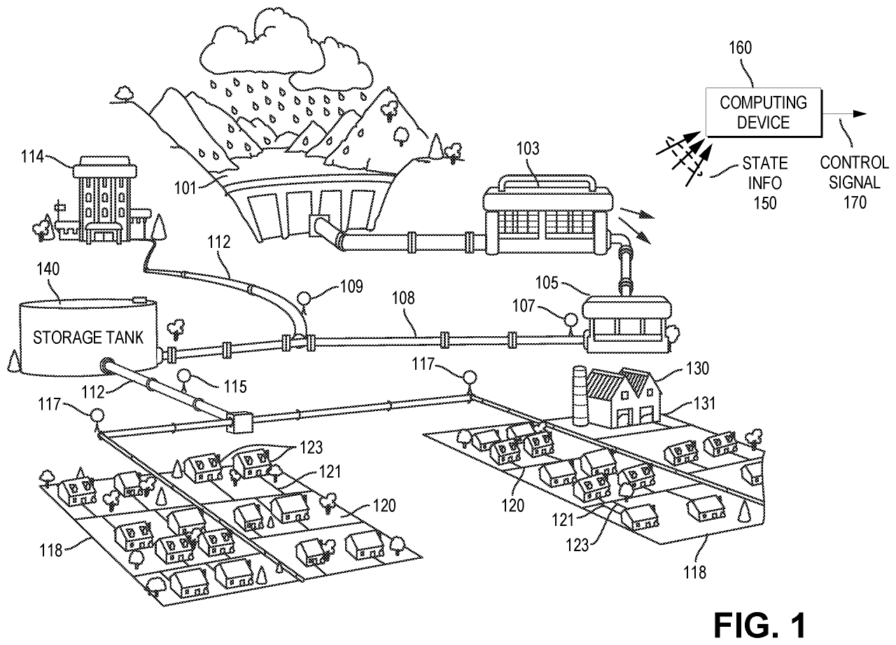

FIG. 1 illustrates elements of one embodiment of water utility infrastructure including a computing device for generating a control signal for flexible consumption. The source of water might be groundwater. The water source might be a reservoir, river, or rainwater catchment area 101.

The raw water from the water source 101 is sent to a water treatment plant 103 and, after treatment, on to a point of production 105. Water leaving the point of production 105 flows through a production meter 107 and through a transmission main 108. In the case of a bulk water customer 114, water flows through a bulk meter 109 to the facility and may also be metered at various sublocations (not shown) within the facility.

Before or after distribution to a bulk water customer 114, water may be stored in one or more storage tanks 130 before flowing through a transmission main 112 and through a zone meter 115, through one or more subdivision meters 117 to one or more subdivisions 118. Within each subdivision 118, water flows through distribution mains 120 through utility meters 123 to domestic lines 121. In some instances, after flowing through one meter 115, water may flow through another meter, such as a multi-unit meter 131 to a residential or commercial multiplex 130, wherein each unit within the multiplex 130 is configured with a utility meter.

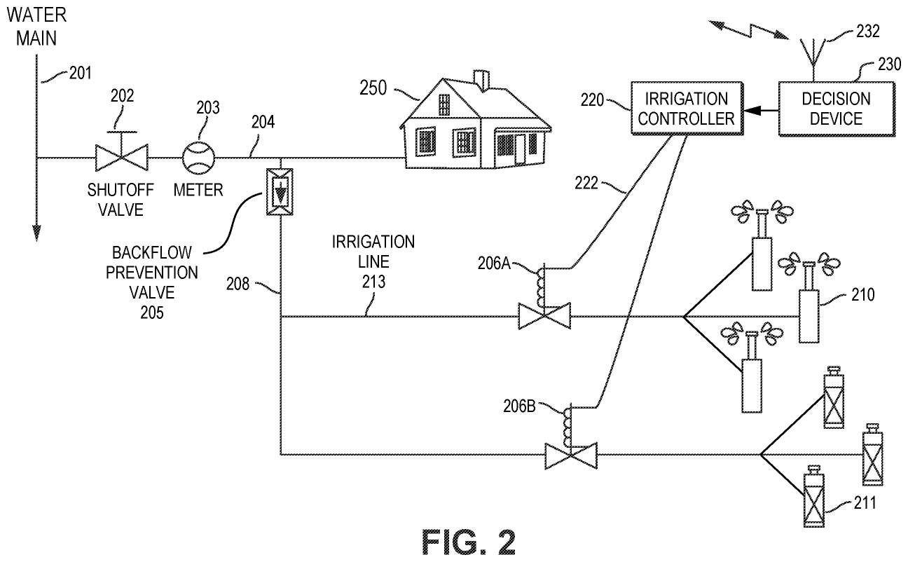

FIG. 2 illustrates one embodiment of a water distribution infrastructure before and after a customer meter including a residential irrigation system incorporating the invention. Water from a water main 201 flows through a utility shut-off valve 202 and then through a meter 203 that measures water volume. The infrastructure up to and including the meter is considered to be utility infrastructure. The infrastructure for supplying the water beyond the meter on the customer side of the meter is considered to be customer infrastructure. The customer supply line 204 supplies water to the residence 250. The customer supply line may branch to supply other structures or uses. In the illustrated embodiment, the customer supply line is branched 208 to feed a number of irrigation lines 213. In the illustrated embodiment a backflow prevention valve 204 is included to protect the customer supply line and utility infrastructure from possible bacterial contamination that might otherwise result from water siphoning back into the customer supply line from the irrigators 210, 211.

In the illustrated embodiment, an irrigation controller 220 controls one or more irrigation valves 206A through 206B. In this example, the irrigation valves 206A are coupled to the irrigation controller 220 via wires 222 to enable the irrigation controller to energize the valve 206A. When the controller energizes a valve 206A to open it, water flows through that valve to the irrigators 210. When a valve 206B is not energized, the valve is closed such that no water flows to the irrigators 211.

In one alternative embodiment, a separate irrigation controller may be utilized for each group 210 of irrigators (i.e., each irrigation valve 213). In another embodiment, each irrigation valve is associated with its own irrigation controller and a single irrigator.

In the illustrated embodiment, a decision device 230 is coupled to the irrigation controller. The decision device includes an antenna 232 for receiving the control signal 170. The decision device determines whether the irrigation controller should be inhibited from allowing irrigation.

Traditional residential irrigation controllers 220 are configured to have an inhibit input (also known as a rain sensor input) for receiving an inhibit signal to control whether irrigation is inhibited. Thus, in the illustrated embodiment, the decision device 230 provides the inhibit signal to the irrigation controller 220 via the inhibit input (rain sensor input) of the irrigation controller. This allows the present invention to be practiced with existing and legacy irrigation controllers. In other embodiments, the decision device is more fully integrated with the controller such that the functionality of the irrigation controller 220 is incorporated into the decision device 230.

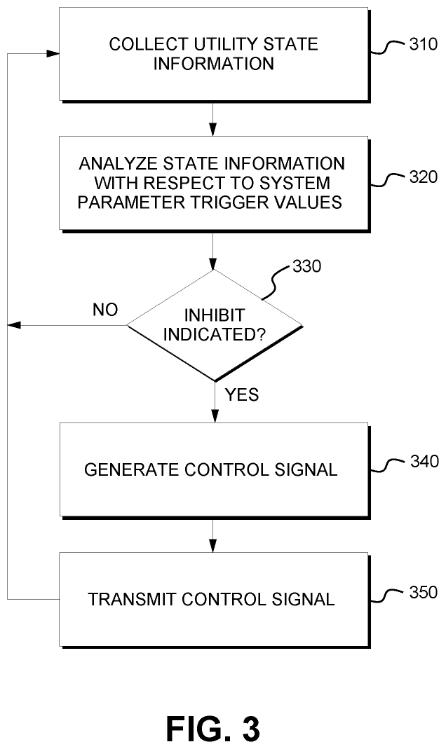

FIG. 3 illustrates one embodiment of a method of generating the control signal by the computing device. Utility infrastructure state information is collected in step 310. This information is intended to represent the current state of the utility infrastructure and generally any information that would be pertinent to whether, when, and how much load shedding needs to take place. The state information includes the values of various system parameters. Examples of state information may include total amount of stored water, aquifer or reservoir water levels, volumetric flow in different parts of the infrastructure, water pressure, water flowrate, water inflow rate and amount, water outflow rate and amount, differences in flow, differences in pressure, etc. The state information can reflect values for one or more of these parameters for different parts of the infrastructure. State information may include customer meter readings/values for water volume or flow specific to a customer. The state information may be ascertained for different portions of the infrastructure. Some values may be sensed, calculated, measured, looked-up, or set. The state information may include additional information such time, date, soil moisture, likelihood of precipitation, load shaping information, and other information that may be pertinent to managing demand for water.

In step 320, the collected state information (i.e., values of system parameters) is analyzed with respect to corresponding system parameter trigger values to determine if an exception has been triggered. An exception may be based on a selected system parameter value meeting or exceeding a corresponding system parameter trigger value. An exception may be based on a selected system parameter value meeting or falling below a corresponding system parameter trigger value. An exception may be based on a selected system parameter value being outside of an acceptable range. An exception may be indicated by a formulaic combination of system parameter values contrasted with a formulaic combination of system parameter trigger values. An exception may be indicated by a more complex “if-then” analysis of the system parameter values.

Step 330 determines whether water use should be inhibited. If not, the method returns to step 310. If water use should be inhibited, the method proceeds with generating the control signal in step 340. In various embodiments the control signal may incorporate information such as types of water use to inhibit (e.g., irrigation, other), the nature of the customer (e.g., commercial, residential, multi-family, etc.), the area of the territory served by the utility to which the control signal is intended to apply, specific customers or customer locations, or other flags to identify to which customers, what uses, or what date/time the customers or uses are to be inhibited.

The computing device then transmits the control signal in step 350. In one embodiment, the control signal is transmitted by broadcast. The term “broadcast” is generally characterized as a communication from a transmitter to one or more receivers.

In a classic broadcast environment (e.g., over-the-air broadcast television, radio, satellite broadcast, etc.), the transmission is unidirectional and the broadcaster has no knowledge of the identity or number of receivers receiving the broadcast. Any receiver within the coverage area of the transmitter can receive the broadcast. In one embodiment, the control signal is transmitted by classic broadcast. More recent broadcasting techniques (e.g., NARROWCAST, POINTCAST, UNICAST, ANYCAST, MULTICAST, etc. such as might be used in a computer network environment) permit specifying a group of one or more intended recipients. As with the classic broadcast environment, these more recent broadcasting techniques do not require bi-directional communication with the receivers. The information is transmitted substantially simultaneously to all members of a specified group of two or more intended recipients (individual recipients might ultimately receive the broadcast information at different times depending upon different latencies within the network topology). In one embodiment, the control signal is transmitted by network broadcast.

FIG. 1 illustrates infrastructure for a potable water distribution system. However, reclaimed water (i.e., non-potable water) is also utilized for irrigation and other purposes. Instead of being supplied by potable water, an irrigation system might be supplied by reclaimed (i.e., non-potable) water necessitating a different plumbing configuration than that illustrated in FIG. 2. However, the quality of the water delivered is not pertinent to the decision device. Although FIG. 3 was discussed in the context of water, the process is applicable to goods or services other than water. The application of the process to different goods or services might vary in the state information collected or monitored and the system parameter trigger values depending upon the nature of the good or service provided. Thus, for example, a potable water utility might utilize one set of system parameters (state information) different from the set of system parameters monitored by a reclaimed (non-potable) water utility such that the system parameters (and trigger values) collected or utilized for purposes of steps 310 and 320 of FIG. 3 may not be identical. However, the process described in FIG. 3 may be utilized with the state information, system parameter trigger values, and analysis appropriate for each application. Accordingly, the term “water” is not intended to be limited to a particular quality (e.g., potable vs. non-potable) unless such is expressly stated or as context dictates.

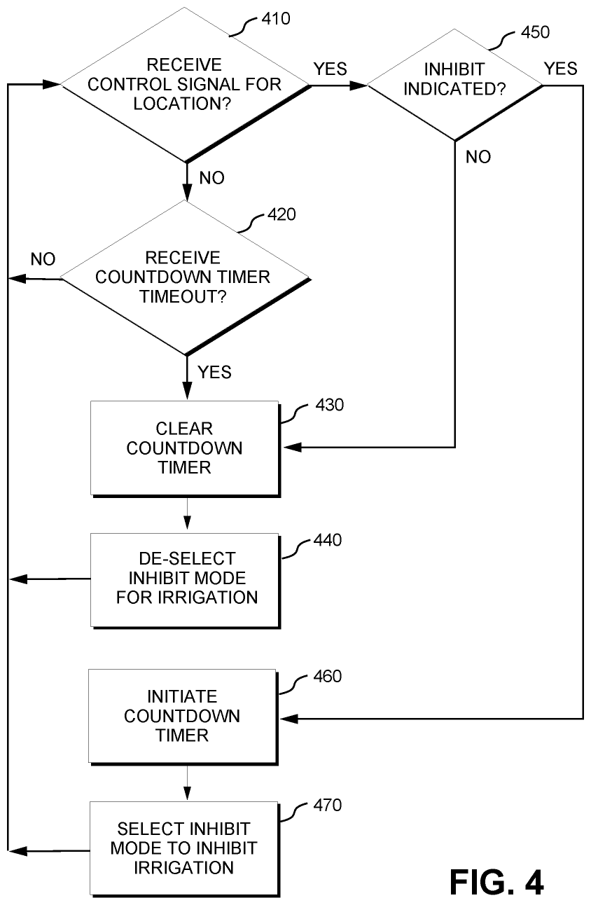

FIG. 4 illustrates one embodiment of the process executed by the decision device 230 of FIG. 2. The decision device receives the control signal. In step 410, the decision device determines whether the control signal is applicable to the receiving location (e.g., whether the control signal is intended for the decision device that received it). If so, step 420 determines whether the control signal indicates the use, i.e., irrigation, should be inhibited at this location.

In one embodiment, the present invention includes a failsafe to prevent the irrigation system from being fixed on an inhibit mode if it does not receive any control signal or a control signal affirmatively de-selecting inhibit mode after a period of time. If step 420 determines an inhibit is indicated, the process continues with step 460 to initiate the failsafe countdown timer. The decision device then selects inhibit mode to inhibit irrigation in step 470. In inhibit mode the decision device asserts the inhibit signal to the irrigation controller to inhibit or supersede the irrigation controller irrigation schedule. The process returns to step 410.

If no control signal is received in step 410, processing continues with step 420 to ascertain whether the countdown timer has indicated a timeout. If not, then processing returns to step 410. Otherwise from step 420, if a timeout is indicated processing continues with step 430 to clear the countdown timer. Step 430 is also reached from step 420 if no inhibit is indicated by the control signal. The decision device then de-selects inhibit mode for irrigation in step 440.

With respect to step 420, the decision device can determine an inhibit is indicated by content of the control signal in conjunction with data specific to the decision device. The content of the control signal can indicate a network address, decision device identifier, physical location or ranges of such addresses, identifiers, or locations which include that of the decision device, or other identifier or combination of identifiers operating to identify the decision device. Data specific to and known to the decision device might include its network address, geographic area identifier, decision device identifier, or whether the decision device is located at an odd or an even street address (i.e., even/odd parity). For example, the control signal may indicate “ODD” addresses are to be inhibited or that odd addresses within an area or range of addresses are to be inhibited. The decision device would determine an inhibit is indicated if it is designated as an odd address and receives a control signal specifying “ODD” addresses are to be inhibited or that odd addresses within an area or range of addresses within which the decision device is located is to be inhibited.

If the control signal provides greater resolution as to the characteristics of the demand response to be controlled such as type of use to inhibit (e.g., irrigation), or nature of the customer (e.g., commercial, residential, multi-family, etc.), the decision device determines an inhibit is indicated in step 420 only if its type of use and nature of the customer match those specified in the control signal. In one embodiment, the decision device is programmable to permit storing location-related, use, or customer-specific information such as whether the customer has an odd or even address, the use is irrigation, and the customer is residential, for example.

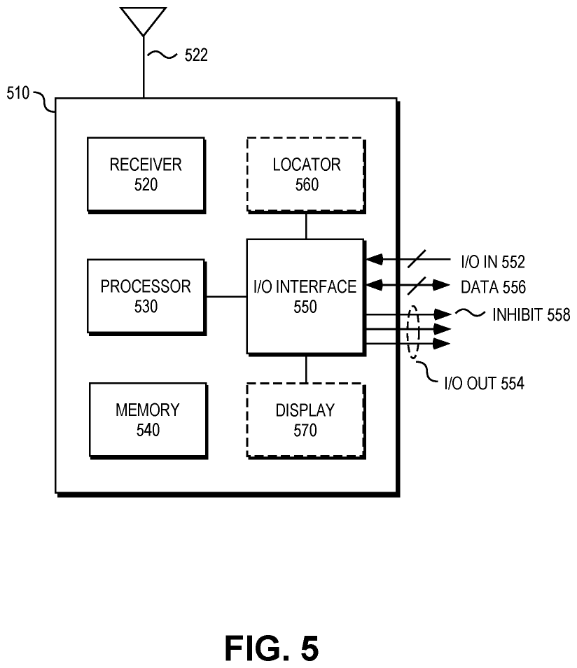

FIG. 5 illustrates one embodiment of a decision device 510. The decision device includes a receiver 520 for receiving the control signal 170 generated by computing device 160 (FIG. 1). In the illustrated embodiment, antenna 522 permits receiver 520 to receive wireless broadcasts. In alternative embodiments, receiver 520 may be coupled to receive broadcasts using physical couplings such as wires or optical fibers.

Decision device 510 includes a memory 540 for storing settings and for working memory when processor 530 is performing the process set forth in FIG. 4 to determine whether to assert an inhibit signal. Decision device 510 includes an input/output (I/O) interface 550 controlling external processes as well as providing an interface between the processor 530 and various peripherals such as a locator 560 or a display 570. The I/O interface may receive inputs from one or more I/O IN 552 lines. The I/O interface may provide outputs on one or more I/O OUT 554 lines. At least one of the I/O OUT lines operates as the INHIBIT 558 signal line for providing an inhibit signal to an irrigation controller. In one embodiment, I/O interface 550 provides a digital output representative of an “on” or “off” signal for the INHIBIT 558 signal line. In an alternative embodiment, I/O interface 550 provides a proportionate signal for INHIBIT 558 in either analog or digital form.

In one embodiment, I/O interface 550 supports communication of data between the device and external processes. The I/O interface may receive and provide data on one or more bi-directional data lines 556. I/O interface 550, for example, may support an application programming interface (API) for retrieving data computed or stored by the device. I/O interface 550 may similarly provide for the receipt of data 556. In one embodiment, programmatic settings for the device are received by I/O interface 550 (i.e., data 556). Settings may include, for example: device region, device identifier, device location, use (irrigation), customer identifier, nature of the customer, even/odd address designation, etc.)

In one embodiment, device 510 includes a locator 560 to permit automatic self-determination of location without user input. Locator 560, for example, may determine position of the device by satellite telemetry. In one embodiment, locator 560 determines the position of the device through satellite trilateration using a satellite constellation. A display 570 may optionally be provided for displaying stored settings. In one embodiment, the display indicates the operational status of the decision device. For example, the operational status may be indicated by colors or patterned light displays such as green (working/inhibit mode de-selected), red (working/inhibit mode selected), and flashing red (problem).

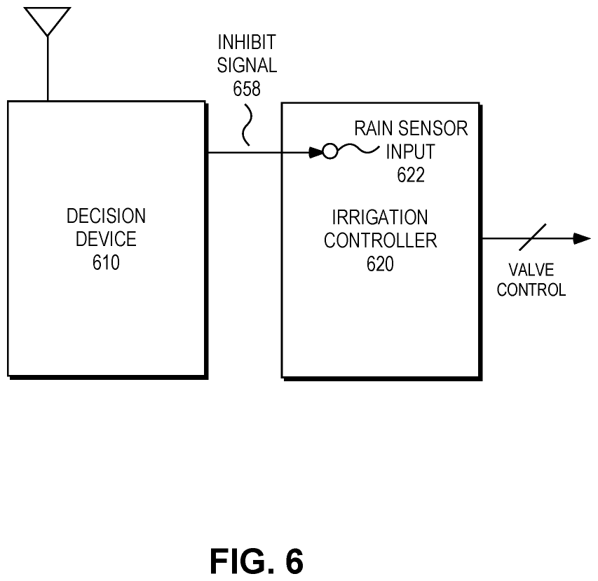

FIG. 6 illustrates one embodiment of a decision device coupled to an irrigation controller. Irrigation controller 620 includes a rain sensor input 622. The rain sensor input serves as an inhibit input. The rain sensor input 622 of the irrigation controller is coupled to receive the inhibit 658 signal output from the decision device 610. The decision device inhibit signal operates to inhibit or interrupt irrigation when asserted. So long as the inhibit signal is asserted the irrigation controller cannot energize any irrigation valves irrespective of the irrigation schedule. The irrigation controller is enabled to irrigate in accordance with its programmed irrigation schedule only when the inhibit signal is de-asserted. When the decision device has selected the inhibit mode, the inhibit signal is asserted and the irrigation controller is likewise placed in inhibit mode to inhibit irrigation. When the decision device has de-selected the inhibit mode, the inhibit signal is de-asserted and the irrigation controller is no longer inhibited from irrigation.

The invention permits managing demand for water based upon dynamic system parameter values on the supply side to maintain storage levels, pressure, flows, etc. In the context of potable water distribution management, the invention permits shedding flexible loads or use demands such as irrigation while not adversely impacting regular domestic use. Irrigation is a flexible load from the perspective of the water utility because it can typically be time-shifted or occasionally omitted without serious deleterious impact. Because irrigation often represents on the order of 70% of all water consumed by a residential customer, management of irrigation is a significant component of managing demand.

One demand management tool utilized by utilities is load shaping. The utility seeks to distribute an expected load or demand over time in a planned manner in order to spread fulfillment of the demand out more evenly over time. In the context of water utilities, load shaping is applied to the customer base with respect to irrigation by dividing the customers into groups and imposing an irrigation schedule limiting which groups are permitted to irrigate at any given time. Load shaping in this fashion is a longer-term planning mechanism for managing demand. Customers are notified of the schedules so that they can modify irrigation controller programs as necessary and the schedules remain in place for extended times (e.g., months or years).

One of the disadvantages of typical water utility load shaping is that compliance with irrigation schedules is voluntary. The water utility may be allowed to impose financial penalties in an effort to compel compliance but some customers are not moved by the financial penalties. In other cases, customers may not be attentive to irrigation schedules or changes to irrigation schedules. Regardless of the cause, lack of compliance with the irrigation schedule by customers can thwart the purpose of load shaping and result in unexpected spikes in demand and reduction in capacity such that the utility's ability to meet peak demand is jeopardized.

The present invention allows the utility to inhibit irrigation in order to ensure compliance with irrigation schedules. The load shaping profile may be represented within the system parameter trigger values. System parameter trigger values utilized by the computing device incorporate information about which customers can irrigate including at what times and what dates. In one embodiment rate or volume of irrigation may also be considered. The result is that the decision devices to which the inhibit control signal is directed will select the inhibit mode and assert the inhibit signal to inhibit the irrigation controller from irrigating in accordance with the load shaping profile set by the water utility.

The benefit to the water utility is better compliance with the irrigation schedule. The benefit to the customers is avoidance of financial penalties and other consequences of failure to abide by irrigation schedules. The benefit to both is greater stability in the demand response in order to ideally extend the time before the utility must expand or seek additional supply in order to meet peak demand.

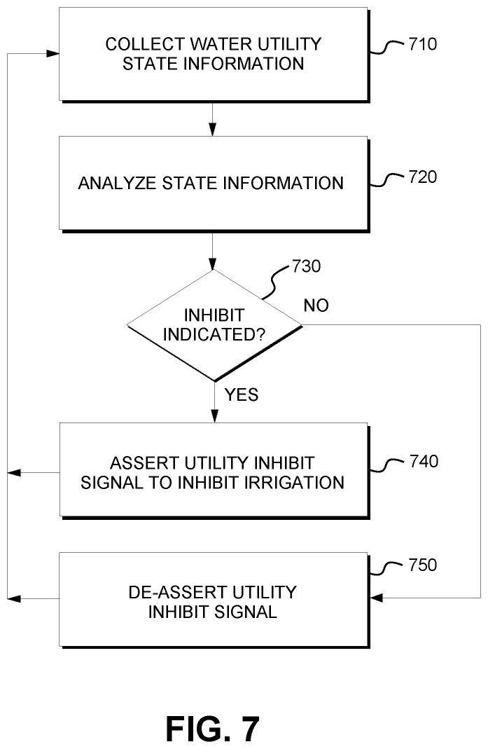

FIG. 7 illustrates one embodiment of a method for controlling irrigation based in part on water utility state information. The water utility state information is collected in step 710. The state information includes system parameter values for parameters pertinent to determining whether the water utility should inhibit irrigation. Examples of such parameters include total amount of stored water, amount of water stored in specific locations, aquifer or reservoir water levels, volumetric flow in different parts of the infrastructure, water pressure, water flowrate, water inflow rate and amount, water outflow rate and amount, differences in flow, differences in pressure, etc. The state information may be ascertained for different portions of the infrastructure. The state information may be sensed, calculated, measured, looked-up, or set.

The state information is analyzed in step 720 to determine if an exception directing inhibition of irrigation has been triggered. An exception may be based on a selected system parameter value meeting or exceeding a corresponding system parameter trigger value. An exception may be based on a selected system parameter value meeting or falling below a corresponding system parameter trigger value. An exception may be based on a selected system parameter value being outside of an acceptable range. An exception may be indicated by a formulaic combination of system parameter values contrasted with a formulaic combination of system parameter trigger values. An exception may be indicated by a more complex “if-then” analysis of the system parameter values.

If an inhibit is indicated as determined in step 730, a utility inhibit signal is asserted to inhibit irrigation in step 740. The term “inhibit signal” is prefaced with “utility” to distinguish among other inhibit signals that might also operate to inhibit irrigation such as an actual rain sensor signal. If an inhibit is not indicated as indicated in step 730, the utility inhibit signal is de-asserted in step 750. De-assertion of the utility inhibit signal will not necessarily enable irrigation. De-assertion of the utility inhibit signal means that any inhibition or suspension of irrigation is due to another reason such as a triggered rain sensor. Each of the processes of FIGS. 3, 4, and 7 may be executed by one or more processors.

Although the invention has been described and illustrated with reference to the specific embodiments, it is not intended that the invention be limited to the illustrative embodiments. Those skilled in the art will recognize that modifications and variations may be made without departing from the spirit and scope of the invention. Therefore, it is intended that this invention encompass all of the variations and modification as fall within the scope of the appended claims.

What is claimed is:

1. A method of managing distribution of water from a water utility comprising the steps of:
i) collecting water utility state information;
ii) analyzing the state information to determine whether to inhibit irrigation by customers receiving water from the water utility; and
iii) inhibiting irrigation based at least in part on the state information.

2. The method of claim 1 wherein the water utility provides potable water.

3. The method of claim 1 wherein the water utility provides non-potable water.

4. The method of claim 1 wherein the state information includes a value for at least one system parameter from the following set: {stored water, water pressure, water flowrate, water inflow rate, water inflow amount, water outflow rate, water outflow amount, aquifer water level, reservoir water level, differences in flowrate, differences in pressure}.

5. The method of claim 1 wherein the state information includes a value for at least one load shaping system parameter from the following set: {location, day of week, time of day, address parity}.

6. A method of managing distribution of water from a water utility comprising the steps of:
i) collecting water utility state information;
ii) analyzing the state information to determine whether to inhibit irrigation by customers receiving water from the water utility; and
iii) transmitting a control signal to inhibit irrigation if step ii) determines irrigation should be inhibited.

7. The method of claim 6 further comprising the steps of:
iv) receiving the control signal;
v) generating an inhibit signal for an irrigation controller in accordance with the control signal, wherein the irrigation controller is coupled to operate an irrigation valve controlling the flow of at least a portion of the water for irrigation, wherein when the inhibit signal is asserted the irrigation controller is inhibited from energizing the irrigation valve whereby irrigation is inhibited.

8. The method of claim 7 wherein the inhibit signal is asserted to inhibit irrigation if the control signal indicates irrigation is to be inhibited for the location of the irrigation controller.

9. The method of claim 6 wherein the state information includes a value for at least one system parameter from the following set: {stored water, water pressure, water flowrate, water inflow rate, water inflow amount, water outflow rate, water outflow amount, aquifer water level, reservoir water level, differences in flowrate, differences in pressure}.

10. The method of claim 6 wherein the state information includes a value for at least one load shaping system parameter from the following set: {location, day of week, time of day, address parity}.

11. An apparatus comprising:
a receiver for receiving a control signal from a water utility, wherein the control signal includes an indication of whether irrigation should be inhibited; and
a processor coupled to receive the control signal from the receiver, wherein the processor determines from the content of the control signal whether the control signal is applicable to the apparatus based on at least one of an id of the apparatus and a location of the apparatus, wherein if the control signal is applicable and indicates irrigation should be inhibited, the processor generates an inhibit signal to inhibit irrigation for provision to an irrigation controller.

12. The apparatus of claim 11 wherein the indication of whether irrigation should be inhibited is derived at least in part from an analysis of the state information of the water utility.

13. The method of claim 12 wherein the state information includes a value for at least one system parameter from the following set: {stored water, water pressure, water flowrate, water inflow rate, water inflow amount, water outflow rate, water outflow amount, aquifer water level, reservoir water level, differences in flowrate, differences in pressure}.

14. The method of claim 12 wherein the state information includes a value for at least one load shaping system parameter from the following set: {location, day of week, time of day, address parity}.

15. The apparatus of claim 11 wherein the indication of whether irrigation should be inhibited is derived at least in part from a water utility irrigation load shaping profile.

16. The apparatus of claim 11 wherein the control signal is applicable if it identifies a location within which the apparatus is located.

17. The apparatus of claim 11 wherein the control signal is applicable if it identifies an id specific to that of the apparatus.

18. The apparatus of claim 11 wherein the control signal is applicable if it identifies an address characteristic matching that characteristic of the address of the apparatus.

19. The apparatus of claim 18 wherein the address characteristic is even/odd parity.

20. The apparatus of claim 11 wherein the apparatus further comprises a display for displaying an operational status of the apparatus.
